(19) United States
(12) Patent Application Publication
(10) Pub. No.: US 2006/0190306 A1
(43) Pub. Date: Aug. 24, 2006

(54) Guest room assigning system, guest room assigning program

(76) Inventor: Tatsuya Ishibashi, Niigata (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/549,113

(22) PCT Filed: Oct. 23, 2003
(86) PCT No.: PCT/JP03/13581

§ 371 Date: Sep. 14, 2005

(51) Int. Cl. G06Q 10/00

(52) U.S. Cl. 705/5

(57) ABSTRACT

A server computer (P2) is configured to allot to a user a guest room to be provided for the user from plural guest rooms, the server computer (P2) including: guest room information storage means (2B) configured to store guest room condition information on the guest rooms as to whether each of the guest rooms is in a condition ready to be provided for the user; guest room judgment means (2C) configured to judge guest rooms as being in the condition ready to be provided for the user based on the guest room condition information obtained upon check-in of the user; and guest room identifier information output means (2E) configured to output guest room identifier information items on the guest rooms judged by the guest room judgment means (2C) according to a predetermined order of priority.

### TECHNICAL FIELD

The present invention is for use in allotting guest rooms of accommodations or like lodgings to users.

### BACKGROUND ART

Conventionally, when a person wants to utilize a guest room of accommodations such as a hotel or an inn, the user makes an inquiry about vacant room information at the accommodations beforehand by telephone, facsimile or the like, and then makes a reservation by specifying a desired type of guest room, the date and time of stay, and like conditions. (See Patent Document 1 for example.)

Then, the accommodations provider allots a vacant guest room to the user at the time of reservation so as to meet the specified conditions of the reservation. That is, which of guest rooms the user will utilize is specified at the time of reservation, and upon check-in the user is guided to the previously specified guest room.

Patent Document 1:

Japanese Patent Laid-Open Publication No. 2003-208480 (p. 3, FIG. 1)

However, with the conventional method of reservation according to which a guest room to be provided for a user is specified at the time of reservation, a time for linen preparations needs to be necessarily secured if the same guest room is provided for different users successively one after the other and, hence, a certain time interval must be provided between the use of the guest room by the preceding user and the use by the succeeding user. Therefore, it has been impossible to accept consecutive reservations over a continuous time slot.

### DISCLOSURE OF INVENTION

Accordingly, the present invention provides a guest room allotting device configured to allot to a user a guest room to be provided for the user from plural guest rooms, comprising: guest room condition information storage means configured to store guest room condition information on the guest rooms as to whether each of the guest rooms is in a condition ready to be provided for the user; guest room judgment means configured to judge guest rooms as being in the condition ready to be provided for the user based on the guest room condition information obtained upon check-in of the user; and guest room identifier information output means configured to output guest room identifier information items on the guest rooms judged by the guest room judgment means according to a predetermined order of priority.

Since this device first allots a guest room to the user upon check-in, not at the time of reservation, it becomes possible to guide the user to a guest room allotted in the order in which readiness is reached without need to take the time for linen preparations and the like into consideration. Therefore, it becomes possible to make consecutive reservations even over a continuous time slot, hence, far improve the time efficiency of the guest rooms. Also, since it is possible to make guest room allotment in the predetermined order of priority automatically, the accommodations provider can eliminate time and labor for the guest room allotment while preventing the user from waiting for the check-in procedure.

The “to output”, as used herein, is meant to include various forms of output including displaying a screen on display means such as a display, printing by a printer or the like, and transmitting to a facsimile apparatus or other device.

If the guest room identifier information output means is configured to output a guest room identifier information item on a guest room of the highest order of priority together with guest room identifier information items on guest rooms of lower order of priority for selection, it becomes possible to provide other guest room other than that allotted preferentially and automatically for a user who attaches importance to a view and hence wishes a guest room facing the sea for example. Thus, it is possible to meet diversified needs of users.

In addition, it is conceivable that the order of priority is determined based on a distance from a front or a management room. With this feature, if a guest room situated closer to the front for example is set to have higher priority, it becomes possible to shorten both the distance the user has to move and the distance the accommodations provider has to move, hence, reduce the burden of transporting the baggage. Alternatively, if guest rooms are centralized at a location close to the management room, it is possible to enhance the working efficiency of cleaning and linen preparations.

In a conceivable specific embodiment, the guest room judgment means is configured to judge a guest room to be provided for a user based on reservation information on reservations of guest rooms which have been made for each of time blocks dividing 24 hours.

In addition, to increase the time efficiency of the guest rooms, the time blocks are preferably made continuous with each other.

Further, if the plural guest rooms are of the same layout, it becomes possible to increase the number of guest rooms in the condition ready to be provided for the user.

### BRIEF DESCRIPTION OF DRAWINGS

FIG. 1 is an illustration showing the overall configuration of one embodiment of the present invention.

FIG. 2 is a block diagram schematically showing the device configuration of a server computer used in the same embodiment.

FIG. 3 is a block diagram showing the functions of the same embodiment.

FIG. 4 is a memory map of the server computer used in the same embodiment.

FIG. 5 is a memory map of the server computer used in the same embodiment.

FIG. 6 is a memory map of the server computer used in the same embodiment.

FIG. 7 shows a screen of a client computer used in the same embodiment.

FIG. 8 shows a screen of the server computer used in the same embodiment.

FIG. 9 shows a screen of the server computer used in the same embodiment.

FIG. 10 shows a screen of the server computer used in the same embodiment.

FIG. 11 shows a screen of the server computer used in the same embodiment.

FIG. 12 shows a screen of the server computer used in the same embodiment.

FIG. 13 is a flowchart of an operation of the server computer used in the same embodiment.

FIG. 14 is a flowchart of an operation of the server computer used in the same embodiment.

### BEST MODE FOR CARRYING OUT THE INVENTION

Hereinafter, one embodiment of the present invention will be described with reference to the drawings.

1. Device Configuration

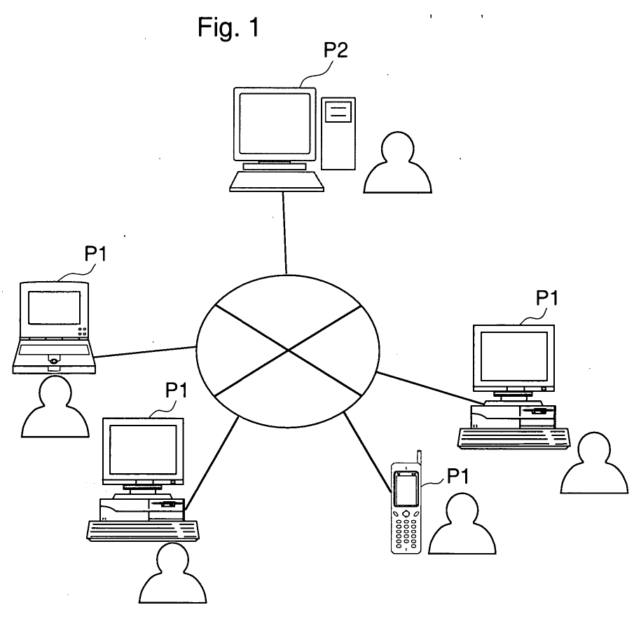

FIG. 1 is a schematic illustration of a system according to the present invention, the system comprising client computers P1 and a server computer P2, which can be connected to each other via a network N such as Internet.

The system according to this embodiment includes client computers P1 to be operated by respective users who utilize such accommodations as a hotel or like lodgings, and server computer P2 belonging to the accommodations provider, the server computer P2 serving as an accommodations reservation conditions search device and a guest room allotting device.

In FIG. 1, reference character P1 designates client computers P1. These client computers P1 are each accessible to the server computer P2 via network N such as Internet. Though each client computer P1 may comprise a mobile phone or a pocket-type personal digital assistant, the present embodiment uses a general-purpose personal computer as client computer P1. Specifically, the computer P1 includes a CPU, internal memory, an external storage device such as a HD, display, a communication interface including a communication component such as a modem and a wireless communication interface such as Bluetooth, and an input device such as a keyboard, which are not shown.

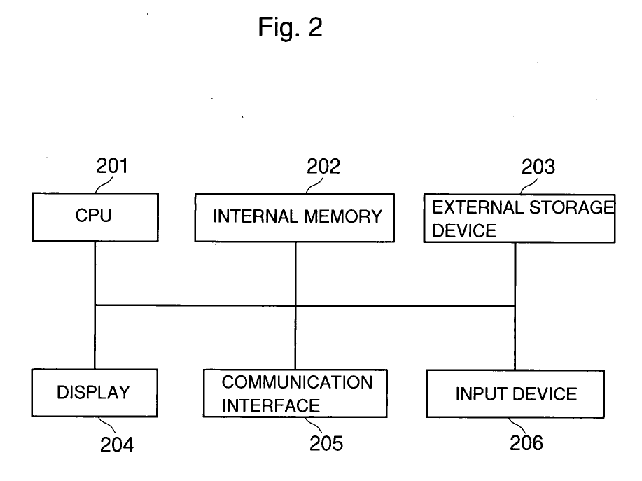

Reference character P2 designates the server computer P2 which is accessible to Internet NET via a routing control device such as a router for example. The server computer P2 has functions including a mail server function having a mail distribution function and a mail management function, a WEB server function, and a database function. As shown in FIG. 2, the server computer P2 includes a CPU 201, internal memory 202, external storage device 203 such as a HD, display 204, communication interface 205 including a communication component such as a modem and a wireless communication interface such as Bluetooth, and an input device 206 such as a keyboard.

Thus, the system according this embodiment utilizes the client computers P1 and the server computer P2, which can be connected to each other for communication via a communications network such as Internet NET.

It does not matter whether the server computer P2 is centralized at one place or distributed.

2. Schematic Functional Configuration

The system according to the present embodiment performs various functions described below by causing the CPU and peripheral devices of each of the client and server computers P1 and P2 to operate according to a predetermined program stored in the storage device of each of the computers P1 and P2. The aforementioned program is previously recorded in a computer-readable recording medium such as CD-ROM for example and then installed in the server computer P2. It is needless to say that the aforementioned program may be installed by downloading it from a host computer having the program stored therein.

Detailed description will be made of each computer.

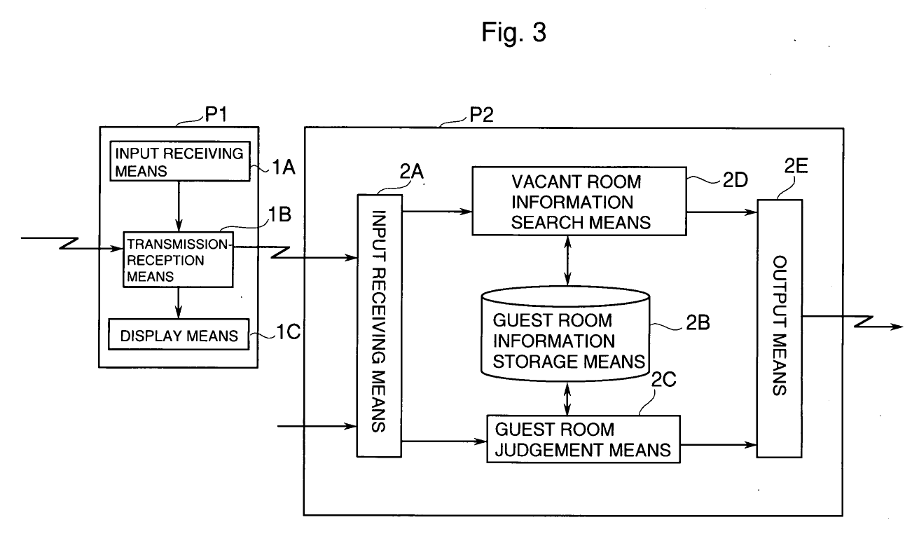

The client computers P1 each have functions as, at least, input receiving means 1A, transmission-reception means 1B, and display means 1C, as shown in FIG. 3.

Here, the input receiving means 1A allows the user to input information required for the user to reserve a guest room, namely, data on the user's desired date and time of stay, the user's desired type of guest room, and the number of guests. The input receiving means 1A mainly comprises a keyboard and the like.

The transmission-reception means 1B is capable of transmission to and reception from the server computer P2 by establishing direct dial-up connection thereto via a telephone line network or connection thereto via Internet NET. The transmission-reception means 1B is accessible to the site by mainly using the communication interface and the like and has the function of transmitting and receiving a variety of data.

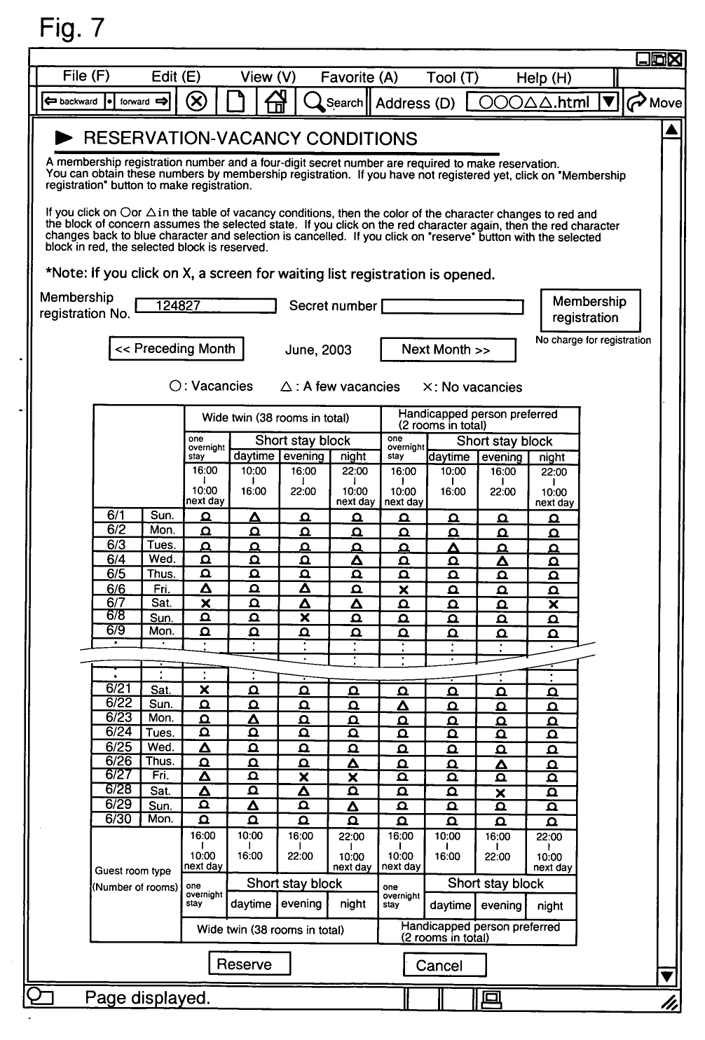

The display means 1C comprises a display or the like for displaying various data transmitted from the server computer P2 as shown in FIG. 7 and has the function of displaying various contents according to display instruction signals.

The server computer P2 used in this embodiment causes the CPU 201 and peripheral devices to operate according to the program or the like stored in its storage device and functions as input receiving means 2A, guest room information storage means 2B, guest room judgment means 2C, vacant room information search means 2D, and output means 2E, as shown in FIG. 3.

Description will be made of the means mentioned above. The input receiving means 2A comprises, as major components thereof, communication interface 205, CPU 201 for controlling the communication interface 205, keyboard, and the like, and receives information transmitted from each client computer P1 and information inputted through the keyboard or the like. Specifically, the input receiving means 2A receives inputs of information required for reservation of a guest room through the server computer P2, namely, information on the user's desired date and time of stay, the user's desired type of guest room, and the number of guests, and information required for guest room allotment, namely, guest room reservation information, registered user information on a user who utilizes a guest room, guest room condition information, and like information, which will be described later.

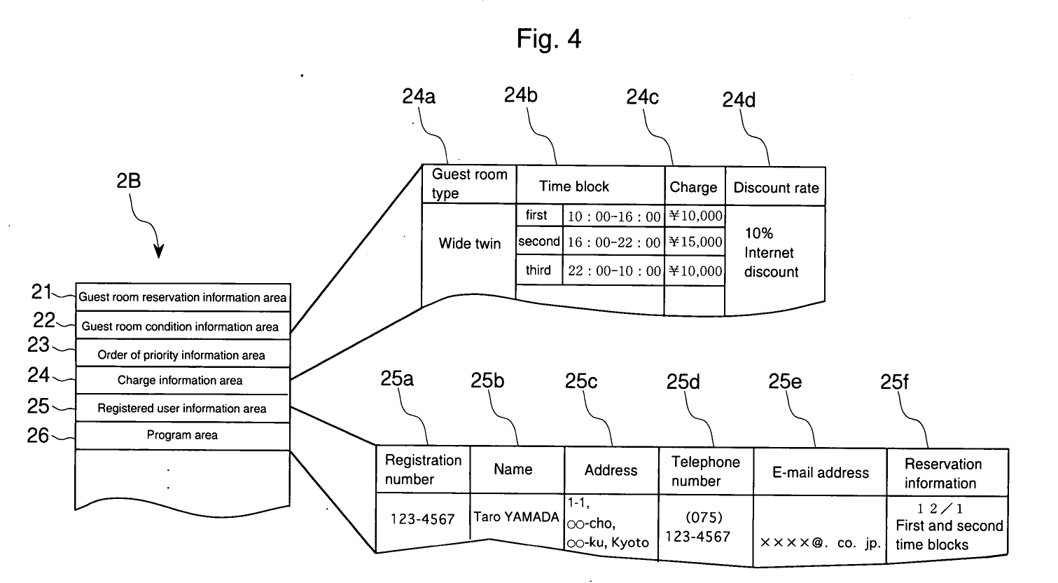

The guest room information storage means 2B has guest room reservation information area 21, guest room condition information area 22, order of priority information area 23, charge information area 24, registered user information area 25, program area 26 and other areas, as shown in FIG. 4.

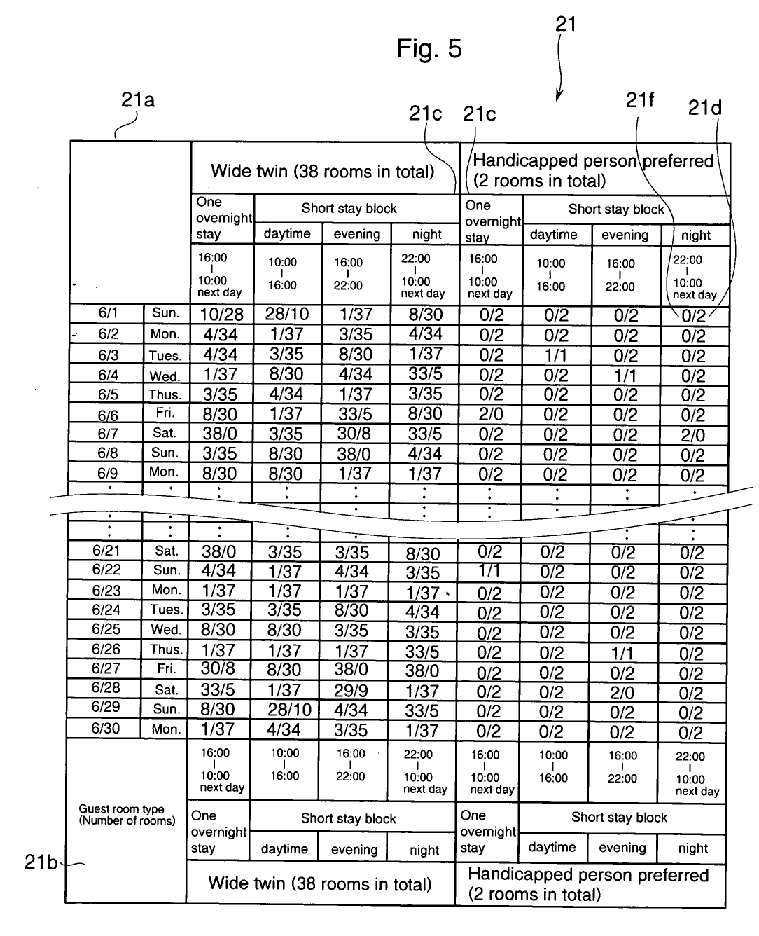

As shown in FIG. 5, the guest room reservation information area 21 has stored therein time blocks 21c for each guest room type 21b on the time axis of the date and time of utilization 21a, each of the time blocks 21c being delimited by start time and end time, vacant room count 21d which is vacant room information for each time block 21c, and reserved room count 21f, which are made associated with each other. Specifically, the time blocks 21c include first time block 21c starting at 10 a.m. and ending at 16 p.m., second time block 21c starting at 16 p.m. and ending at 22 p.m., and third time block 21c starting at 22 p.m. and ending at 10 a.m. next day. In this way 24 hours are divided into three blocks and the end time of each time block 21c is continuous with the start time of the succeeding time block 21c.

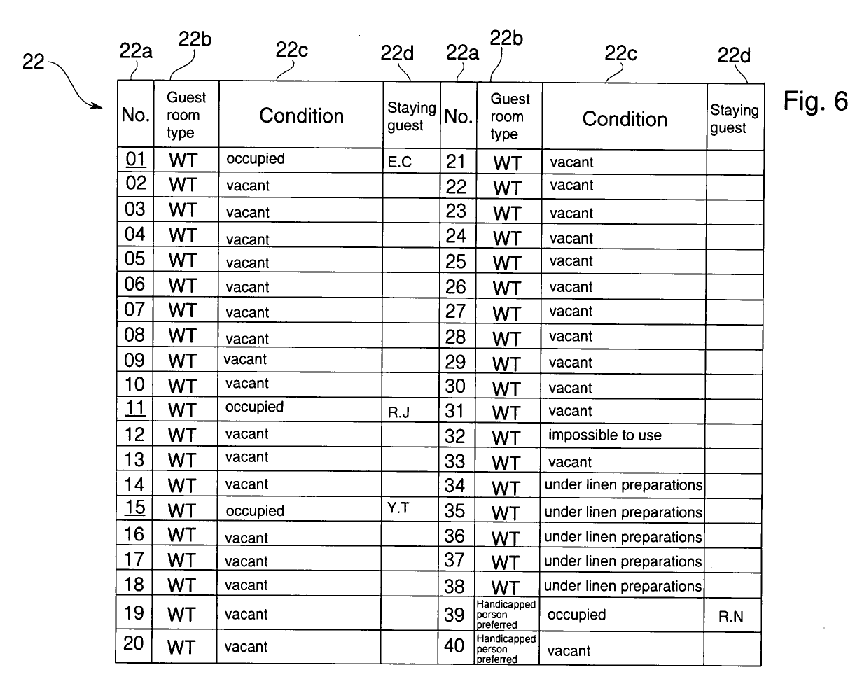

As shown in FIG. 6, the guest room condition information area 22 has stored therein guest room types 22b and guest room conditions 22c including “vacant”, “occupied”, “scheduled to C.O”, “under lien preparations”, “impossible to use”, and like conditions, for respective guest room numbers 22a. The guest room conditions 22c are subjected to update whenever necessary. The guest room condition “vacant” indicates that the guest room of concern is ready to be provided for a user, while the guest room conditions “occupied”, “scheduled to C.O”, “under lien preparations”, “impossible to use” indicate that the guest room of concern is not ready to be provided for a user. The guest room condition information 22 is stored as associated with each of the time blocks dividing 24 hours, namely, the continuous first to third time blocks. Also, staying guest information 22d is stored as associated with a guest room in the “occupied” condition.

The aforementioned guest room condition information items can be changed one from another either automatically or manually. Specifically, in response to an input of information to the effect that linen preparations have been completed, the condition of a guest room of concern is automatically changed to “vacant”. Also, when a guest to stay is fixed by a check-in or stay schedule change, the condition of a guest room of concern is automatically changed to “occupied”. The “scheduled to C.O” indicates that checkout time is drawing near, for example, 30 minutes before the scheduled time. When the checkout time comes near at hand, the condition of a guest room of concern is automatically changed to “scheduled to C.O”. When a guest room of concern becomes unoccupied due to a checkout or stay schedule change, the condition of the guest room is automatically changed to “under lien preparations”. When a guest room of concern becomes impossible to use due to some reasons, the condition of the guest room is automatically changed to “impossible to use”. The guest room condition information items may be changed one from another manually.

The order of priority information area 23 has stored therein information determining the order of priority according to which one of plural guest rooms in a condition ready to be provided is allotted to a user. According to the order of priority, the output means 2E to be described later outputs a guest room identifier information item indicative of the guest room to be provided. In the present embodiment, the order of priority is determined based on the distance from the front; specifically, the order of priority of a guest room situated closer to the front is set higher and guest rooms are given respective room numbers according to the order of priority. Alternatively, it is possible to set higher the order of priority of a guest room situated closer to the management room.

The charge information area 24 has stored therein charges 24c corresponding to respective guest room types 24a and respective time blocks 24b, and discount rate calculation information 24d.

The registered user information area 25 has stored therein personal information on users including name 25b, address 25c, telephone number 25d, E-mail address 25e and like information, as associated with a registration number 25a allotted to each user, reservation information 25f on each user, and like information.

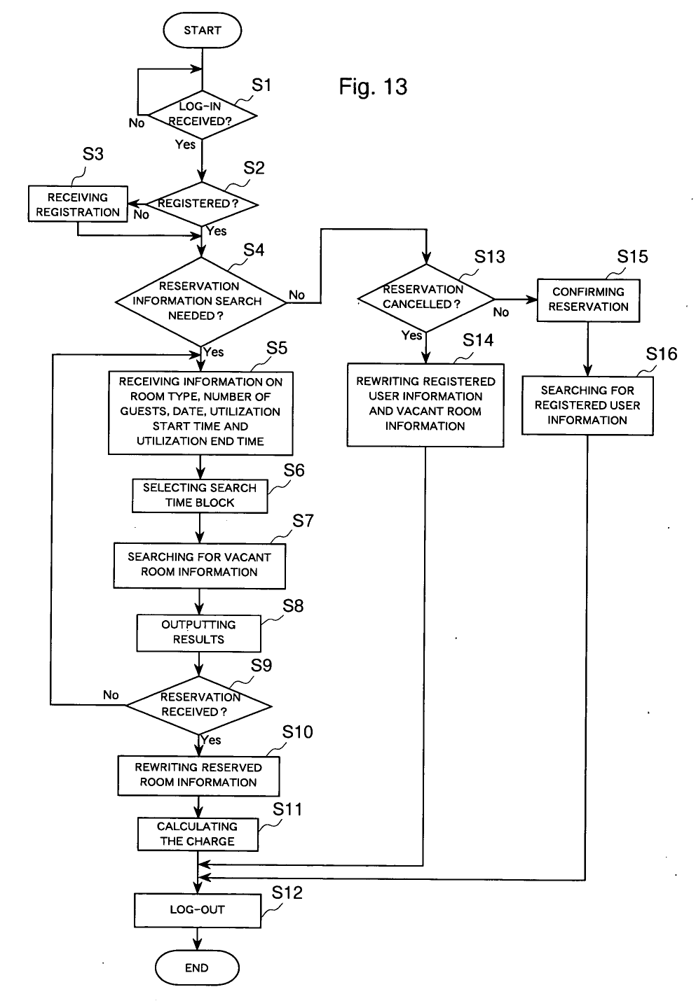

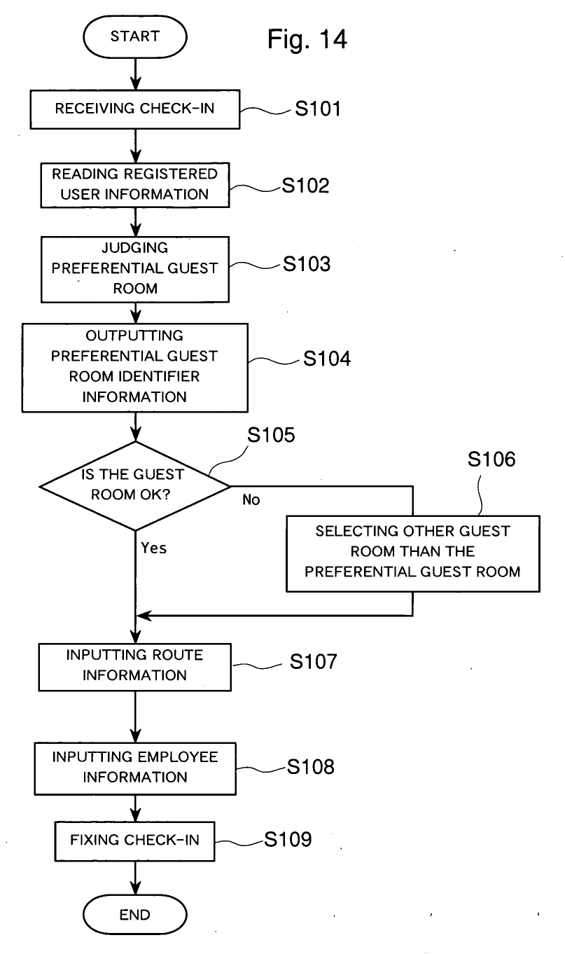

The program area 26 has stored therein a program for causing CPU 201 and the like to carry out flows of operations shown in FIGS. 13 and 14, and like programs.

The guest room judgment means 2C mainly comprises the CPU 201 and the like and references the aforementioned guest room information storage means 2B to judge guest rooms as being in a condition ready to be provided for a user based on the guest room condition information obtained at the time of the user's check-in and the reservation information on the user. Specifically, if the condition of a guest room is “vacant”, the guest room judgment means 2C judges the guest room as being in the condition ready to be provided for the user and sends a ready signal made associated with the guest room identifier information to the output means 2E. Also, the guest room judgment means 2C judges the guest room to be provided for the user based on reservation information on reservations of guest rooms which have been made for each of the time blocks dividing 24 hours.

The vacant room information search means 2D has the function of searching the aforementioned guest room information storage means 2B for vacant guest rooms based on information received from the input receiving means 2A which is required for a user to make a reservation, namely, data on the user's desired date and time of stay, desired type of guest room, the number of guests, and the like.

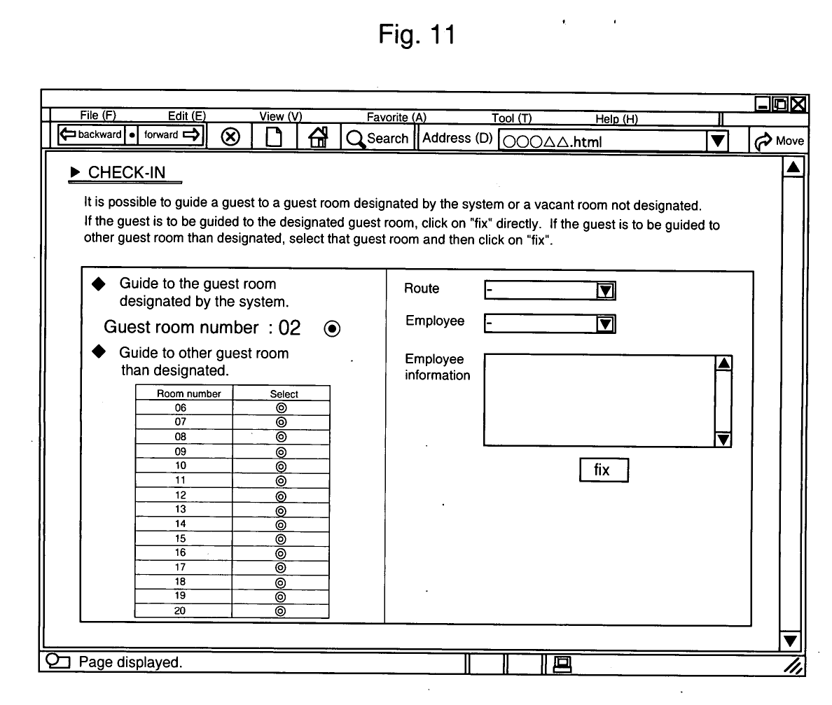

The output means 2E serves as the guest room identifier information output means which outputs guest room identifier information items on guest rooms judged as being ready to be provided for the user by the guest room judgment means 2C according to the predetermined order of priority while having the function of outputting the results of search made by the vacant room information search means 2D. The output means 2E outputs a guest room identifier information item on a guest room of the highest priority together with guest room identifier information items on guest rooms of lower priority for selection, as shown in FIG. 11. The guest room identifier information item of the highest priority, or the guest room number of the highest priority in the present embodiment, is outputted so as to be distinguishable from other guest room identifier information items of lower priority.

Here, “to output” is meant to include displaying on the display 204 of the server computer P2, and transmitting various data to each client computer P1.

3. Description of Operations

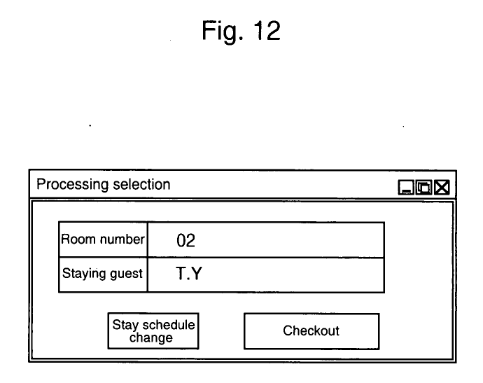

Description will be made of an example of the operation of the present system with reference to FIGS. 7 to 14.

(1) With reference to FIG. 13, description will be made of the flow of operation in which a user makes search for a guest room, reservation of the guest room and the like with respect to the server computer P2 of the accommodations provider by the use of client computer P1.

Initially, the user causes the client computer P1 to connect and log in to the server computer P2 via the network N such as Internet. Then, the server computer P2 receives log-in information (step S1: YES). If the user is not registered yet (step S2: NO), the server computer P2 transmits a screen prompting the user to register the user, receives such information as the name, E-mail address and telephone number of the registrant, and then transmits a registration number 25a to enable the user to search for reservation conditions (step S3). On the other hand, if the user has been registered previously (step S2: YES), the server computer P2 transmits selection screens allowing the user to select any one of the options: making a reservation of accommodations, canceling a reservation of accommodations and confirming a reservation of accommodations.

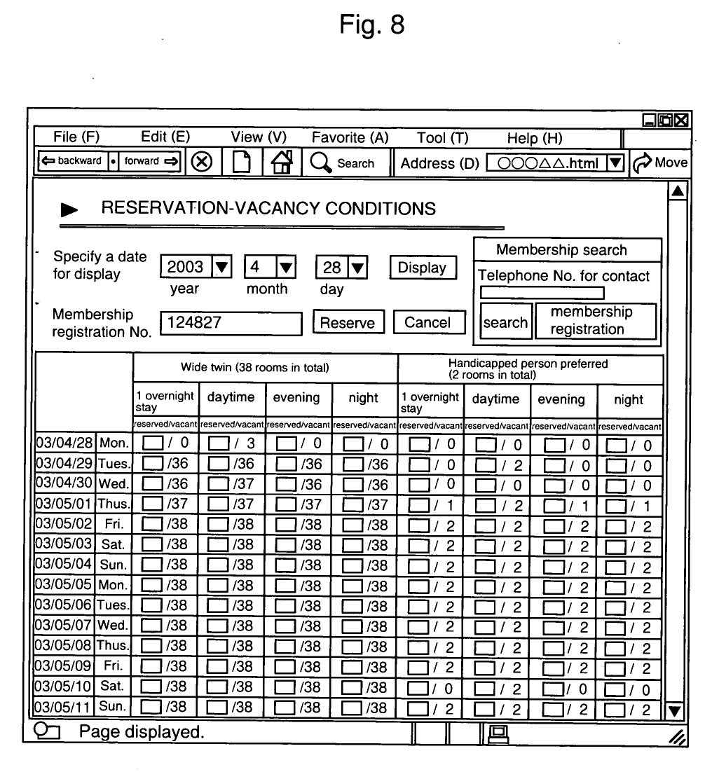

Here, if the screen for making a reservation of accommodations is selected (step S4: YES), the server computer P2 transmits a reservation reception initiating screen as shown in FIG. 7 and then receives such information as a type of guest room desired to reserve, the number of guests, the desired date, and a desired time block by the input receiving means 2A (step S5). More specifically, the server computer P2 receives guest room reservations for each of the time blocks dividing 24 hours or for each overnight stay. The time blocks are continuous with each other. There are plural types of guest room including a wide twin type and a handicapped person preferred type, and plural guest rooms have the same layout. Accordingly, a reservation is received by specifying such conditions as a desired type of guest room and a desired number of guest rooms without specifying a room number. The guest room vacancy information is displayed as such symbols as “O”, “Δ” and “X” so that the degree of vacancy can be seen. FIG. 8 shows a screen displayed on the server computer P2 which shows reservation-vacancy conditions. Like FIG. 8, it is possible to employ a configuration adapted to display the number of vacant rooms and allow an input of the number of guest rooms desired to be reserved.

Based on the information thus received, the server computer P2 searches for vacant room information 21d meeting the user's desired guest room by the vacant room information search means 2D. In the search procedure, the server computer P2 first selects a search time block required to search for a vacant room, which is a time block the user desires to reserve, specifically, a specific time block or a time block covering one overnight stay (step S6).

Subsequently, the server computer P2 searches the guest room reservation information area 21 of the guest room information storage means 2B for vacant room information 21d based on the information on the user's desired guest room type and date and the aforementioned search time block by the vacant room information search means 2D (step S7).

Upon completion of search, the server computer P2 causes the output means 2E to transmit either a screen notifying the user that there is a vacant guest room and prompting the user to confirm the reservation if there is a vacant guest room or a waiting list registration screen if there is no vacant guest room (step S8). If the server computer P2 receives information to the effect that a reservation is to be made (step S9), the server computer P2 receives the reservation by reservation means comprising the CPU 201 and the like and then rewrites the information stored in the guest room information storage means 2B to reduce the vacant room count and increase the reserved room count (step S10) while storing reservation information on the scheduled date of stay and the like made associated with the registration number 25a of the user into the registered user information area 25.

Subsequently, the server computer P2 reads charge information associated with the time block 24b reserved by the user from the charge information area 24 of the guest room information storage means 2B and calculates the charge for utilization of accommodations (step S11).

After the charge has been calculated, the server computer P2 causes the output means 2E to transmit the result of calculation to the client computer P1. When the server computer P2 receives a log-out signal from the client computer P1 (step S12), the flow of operation including reservation conditions search is ended.

Alternatively, if the reservation cancel screen is selected after log-in (step S13), the server computer P2 causes the guest room information storage means 2B to rewrite the guest room reservation information and the registered user information (step S14). If a reservation confirmation screen is selected (step S15), the server computer P2 confirms the user's reservation by referencing the registered user information (step S16) and then transmits the result of confirmation to the client computer P1. When the server computer P2 receives a log-out signal from the client computer P1 (step S12), the flow of operation including reservation information search is ended.

While the above-described flow is directed to the case where a guest room is newly reserved, it is possible to search for vacant room information when a change of the date and time of stay is received.

(2) With reference to FIG. 14, description will be made of the flow of operation for allotting a guest room to the user for actual use.

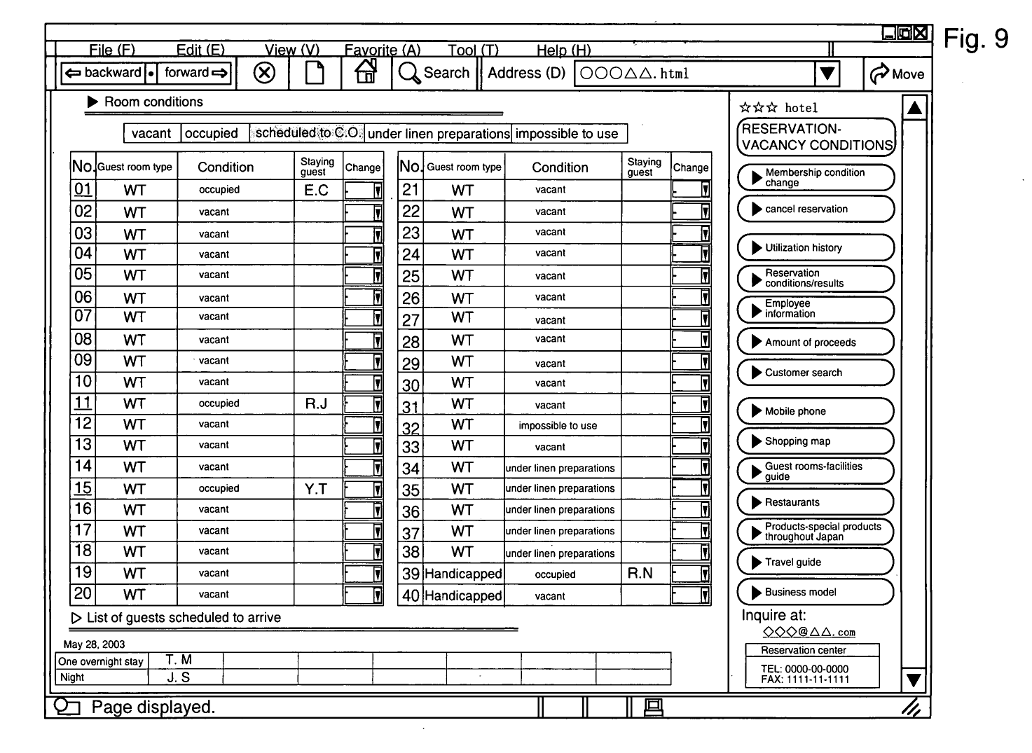

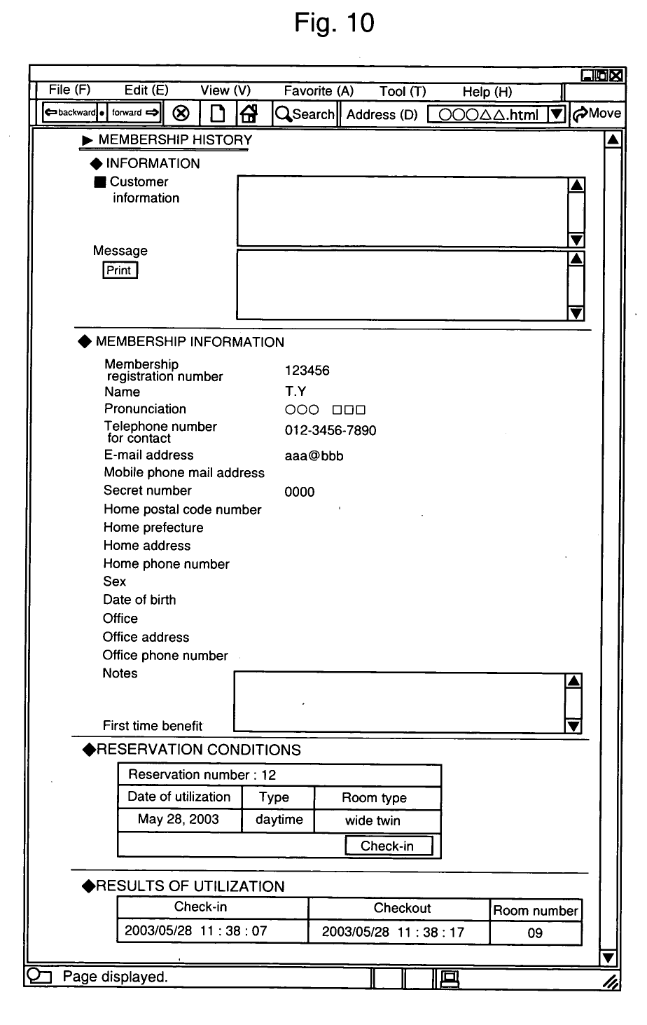

Initially, the server computer P2 displays a screen shown in FIG. 9 as a main screen. When the server computer P2 receives check-in information on the user by the input receiving means 2A (step S101), the server computer P2 starts a check-in operation. Specifically, when the name of a guest to check in is selected from a list of guests scheduled to arrive displayed on the screen by clicking, the registered user information stored in the guest room information storage means 2B is read (step S102) and then a screen showing membership information such as a membership registration number and reservation information including a desired guest room type and a desired utilization time block is displayed as shown in FIG. 10.

After having checked the information displayed on the screen, the server computer P2 receives information clicked on by a check-in button and then judges a guest room ready to be provided for the user whose check-in has been received by using the guest room judgment means 2C (step S103). Specifically, the guest room judgment means 2C references the guest room information storage means 2B to judge a guest room as being in a condition ready to be provided for the user, that is, in a “vacant room” condition.

If there are plural guest rooms in the condition ready to be provided for the user as shown in FIG. 9, the server computer P2 outputs a guest room identifier information item to be allotted preferentially according to the predetermined order of priority on the screen (step S104). If there are other guest rooms in the condition ready to be provided for the user at that time, guest room identifier information items on the other guest rooms are displayed together with the preferential guest room identifier item for selection on the same screen.

If the user wishes other guest room than automatically allotted to the user preferentially (step S105: NO), selection of a desired one of the other guest rooms displayed on the screen by means of a radio button (step S106) makes it possible to allot the selected guest room to the user in place of the preferentially allotted guest room.

Thereafter, the server computer P2 receives inputs of information on the route to the guest room of concern and information on an employee in charge (steps S107 and 108) and fixes the check-in operation (step S109).

As described above, since allotment of a guest room is first made upon check-in, not at the time of reservation, it becomes possible to guide the user to a guest room allotted in the order in which readiness is reached without need to take the time for linen preparations and the like into consideration. Therefore, it becomes possible to make consecutive reservations even over a continuous time slot, hence, far improve the time efficiency of the guest rooms. Also, since it is possible to make guest room allotment in the predetermined order of priority automatically, the accommodations provider can eliminate time and labor for the guest room allotment while preventing the user from waiting for the check-in procedure.

Further, since guest room identifier information items on guest rooms of lower priority can be outputted together with a guest room identifier information item on a guest room of the highest of priority for selection, it becomes possible to provide other guest room other than that automatically and preferentially allotted for a user who attaches importance to a view and hence wishes a guest room facing the sea for example. Thus, it is possible to meet diversified needs of users.

In addition, with the configuration wherein the order of priority is determined based on the distance from the front or the management room; for example, a guest room situated closer to the front is set to have higher priority, it becomes possible to shorten both the distance the user has to move and the distance the accommodations provider has to move, hence, reduce the burden of transporting the baggage. Alternatively, if guest rooms to be used are centralized at a location close to the management room, it is possible to enhance the working efficiency of cleaning and linen preparations.

By judging a guest room to be provided for a user based on reservation information on reservations of guest rooms which have been made for each of the time blocks dividing 24 hours, it is possible to increase the time efficiency of the guest rooms.

In addition, by making the time blocks continuous with each other, no waste of time occurs.

Further, if plural guest rooms are of the same layout, it becomes possible to increase the number of guest rooms in a condition ready to be provided for the user.

It should be noted that present invention is, of course, not limited to the above-described configurations. Other features may be modified variously without departing from the concept of the present invention.

For example, though the order of priority is determined based on the distance from the front or the like in the present embodiment, such a configuration may be employed that plural priorities are provided for selective use.

### INDUSTRIAL APPLICABILITY

In the present invention, allotment of a guest room is made according to the predetermined order of priority by reference to guest room conditions at the time of check-in, whereby there is no need to consider the time for linen preparations and the like into consideration in making reservation, which leads to a rapid improvement in the time efficiency of guest rooms. Further, the present invention can realize efficient guest room allotment while reducing the time and labor of the accommodations provider.

1-12. (canceled)

13. A guest room allotting device configured to allot to a user a guest room to be provided for the user from plural guest rooms, comprising:
guest room condition information storage means configured to store guest room condition information on the guest rooms as to whether each of the guest rooms is in a condition ready to be provided for the user;
guest room judgment means configured to judge guest rooms as being in the condition ready to be provided for the user based on the guest room condition information obtained upon check-in of the user; and
guest room identifier information output means configured to output guest room identifier information items on the guest rooms judged by the guest room judgment means according to a predetermined order of priority.

14. The guest room allotting device according to claim 13, wherein the guest room identifier information output means is configured to output a guest room identifier information item on a guest room of the highest order of priority together with guest room identifier information items on guest rooms of lower order of priority for selection.

15. The guest room allotting device according to claim 14, wherein the order of priority is determined based on a distance from a front or a management room.

16. The guest room allotting device according to claim 13, wherein the guest room judgment means is configured to judge a guest room to be provided for the user based on reservation information on reservations of guest rooms which have been made for each of time blocks dividing 24 hours.

17. The guest room allotting device according to claim 15, wherein the guest room judgment means is configured to judge a guest room to be provided for the user based on reservation information on reservations of guest rooms which have been made for each of time blocks dividing 24 hours.

18. The guest room allotting device according to claim 17, wherein the time blocks are continuous with each other.

19. The guest room allotting device according to claim 13, wherein the plural guest rooms are of a same layout.

20. A program for operating a guest room allotting device configured to allot to a user a guest room to be provided for the user from plural guest rooms, the program being configured to cause the guest room allotting device to function as:
guest room condition information storage means configured to store guest room condition information on the guest rooms as to whether each of the guest rooms is in a condition ready to be provided for the user;
guest room judgment means configured to judge guest rooms as being in the condition ready to be provided for the user based on the guest room condition information obtained upon check-in of the user; and
guest room identifier information output means configured to output guest room identifier information items on the guest rooms judged by the guest room judgment means according to a predetermined order of priority.

21. The program according to claim 20, which is configured to cause the guest room allotting device to function as the guest room identifier information output means configured to output a guest room identifier information item on a guest room of the highest order of priority together with guest room identifier information items on guest rooms of lower order of priority for selection.

22. The program according to claim 21, which is configured to cause the guest room allotting device to determine the order of priority based on a distance from a front or a management room.

23. The program according to claim 20, which is configured to cause the guest room allotting device to function as the guest room judgment means configured to judge a guest room to be provided for the user based on reservation information on reservations of guest rooms which have been made for each of time blocks dividing 24 hours.

24. The program according to claim 22, which is configured to cause the guest room allotting device to function as the guest room judgment means configured to judge a guest room to be provided for the user based on reservation information on reservations of guest rooms which have been made for each of time blocks dividing 24 hours.

25. The program according to claim 24, which is configured to cause the guest room allotting device to function as the guest room judgment means configured to judge a guest room to be provided for the user based on reservation information on reservations of guest rooms made for each of the time blocks, the time blocks being continuous with each other.

26. The program according to claim 20, which is configured to cause the guest room allotting device to allot to the user a guest room selected from plural guest rooms of a same layout.
